(19) United States
(12) Patent Application Publication
(10) Pub. No.: US 2008/0061717 A1
(43) Pub. Date: Mar. 13, 2008

(54) Led Array

(75) Inventors: Georg Bogner, Lappersdorf (DE); Moritz Engl, Regensburg (DE); Markus Hofmann, Bad Abbach (DE); Joachim Reill, Zeitlarn (DE); Thomas Reiners, Bachhagel (DE)

Correspondence Address: FISH & RICHARDSON PC, P.O. BOX 1022, MINNEAPOLIS, MN, 55440-1022, US

(73) Assignee: OSRAM OPTO SEMICONDUCTORS GMBH, Regensburg (DE)

(21) Appl. No.: 11/575,899

(22) PCT Filed: Sep. 9, 2005
(86) PCT No.: PCT/DE05/01582

§ 371 Date: Nov. 14, 2007

(30) Foreign Application Priority Data
Sep. 30, 2004 (DE) 10 2004 047 682.9

(51) Int. Cl. H05B 37/02

(52) U.S. Cl. 315/309

(57) ABSTRACT

An LED array comprising at least two LED chips (2) contains a temperature sensor (3), and means are provided for regulating the operating current of the LED chips (2) as a function of the temperature detected by the temperature sensor (3). This makes it possible for the LED chips (2) to be operated for long periods at high operating current, thereby reducing the risk of thermal overload.

The invention relates to an LED array in accordance with the preamble of Claim 1.

This patent application claims the priority of German Patent Application 102004047682.9, whose disclosure content is hereby incorporated by reference.

LED arrays are distinguished by high efficiency, long life, fast response times and relatively low sensitivity to impacts and vibrations. For this reason, LED arrays are being used more and more frequently in lighting devices where incandescent lamps have often been employed heretofore, particularly in motor vehicle headlights, reading lamps or flashlights.

In the LED arrays used for such lighting purposes, the LED chips are usually operated at very high operating currents to obtain the highest possible luminance. This is associated with high heat generation, however. Compact LED lighting devices also often include integrated beam-shaping optical elements that are disposed very close to or even on the LED chips. This further impairs heat dissipation from the chip.

The object underlying the invention is to specify an LED array with which the risk of thermal overload of the LED chip is reduced.

This object is achieved by means of an LED array having the features of Claim 1. Advantageous configurations and refinements of the invention are the subject matter of the dependent claims.

According to the invention, an LED comprising at least two LED chips contains a temperature sensor, and means are provided for regulating an operating current of the LED chip as a function of the temperature detected by the temperature sensor.

By regulating the operating current of the LED chips of the LED array in a temperature-dependent manner, it is possible to avoid impairment of the operation of the LED chip, or even failure thereof, due to thermal overload. For example, the temperature detected by the temperature sensor can be evaluated by an evaluation circuit, preferably disposed outside the LED array, and the operating current of the LED chip can be lowered as soon as the temperature detected by the temperature sensor reaches a critical value. In this way, the LED chips can advantageously be used for long periods of operation approaching their ultimate thermal capacity.

The invention is particularly advantageously applicable to LED arrays containing large numbers of LED chips, since as the number of LED chips increases, so does heat generation. An LED array according to the invention particularly preferably contains at least four LED chips.

To achieve the best possible agreement between the temperature detected by the temperature sensor and the temperature of the radiation-emitting active layers of the LED chips, it is advantageous if the temperature sensor is located at the smallest possible distance from at least one of the LED chips. The distance between the temperature sensor and at least one LED chip of the LED array is preferably 5 mm or less, particularly preferably 3 mm or less. It is further advantageous for the temperature measurement of the LED chip if the individual LED chips of the LED array have no LED housing.

The LED array preferably comprises a chip carrier on which the LED chips are disposed, and the temperature sensor is attached to the chip carrier. The chip carrier is preferably made of a ceramic. The chip carrier may in particular contain AlN.

The temperature sensor, for example a heat-dependent resistor, is preferably printed on the chip carrier. This advantageously makes it possible for the distance between the chip carrier and the temperature sensor to be relatively small.

Alternatively, a chip carrier to which the LED chips are attached can be mounted on a carrier body, and the temperature sensor can be attached to the carrier body. The carrier body and the chip carrier are preferably glued together in this case. The temperature sensor for example is attached to the chip carrier or to the carrier body by soldering or gluing. This ensures precisely defined temperature measurement, particularly in environments where the LED array is exposed to impacts or vibrations, for example when it is used in a motor vehicle.

The invention is particularly advantageous for compact LED arrays in which the chip carrier and/or the carrier body have a base area of 300 mm² or less. The chip carrier preferably has a height of less than 1 mm, for example approximately 0.5 mm to 0.7 mm, and the carrier body a height of approximately 1 mm to 1.5 mm.

The temperature sensor is preferably a thermocouple. The temperature sensor can also be a temperature-dependent resistor, which can have a negative temperature coefficient (NTC resistor) or a positive temperature coefficient (PTC resistor). Alternatively, a semiconductor component, for example a transistor or a diode, can be used as a temperature sensor, in which case a temperature-dependent electrical property of such a semiconductor component is detected by an evaluation circuit.

The invention is particularly advantageous for LED arrays in which heat generation is very high due to high power dissipation from the LED chip, and heat dissipation is impaired for example by a high environmental temperature or the design of the LED array. In particular, heat dissipation in LED arrays is often hampered by beam-shaping optical elements disposed very close to, or even on, the LED chips. Such a beam-shaping optical element can for example be an optical concentrator used to exert an advantageous effect on the radiation characteristic of the LED array.

The optical concentrator is preferably a CPC-, CEC- or CHC-type optical concentrator, by which is meant a concentrator whose reflective side walls at least partially and/or at least to the greatest possible extent are in the form of a compound parabolic concentrator (CPC), a compound elliptic concentrator (CEC), and/or a compound hyperbolic concentrator (CHC).

An LED array according to the invention can for example be part of a lighting device, particularly part of a motor vehicle headlight. Since LED arrays in lighting devices are often exposed to high environmental temperatures, which may for example be about 125° in the case of a motor vehicle headlight, the invention is particularly advantageous for such lighting devices.

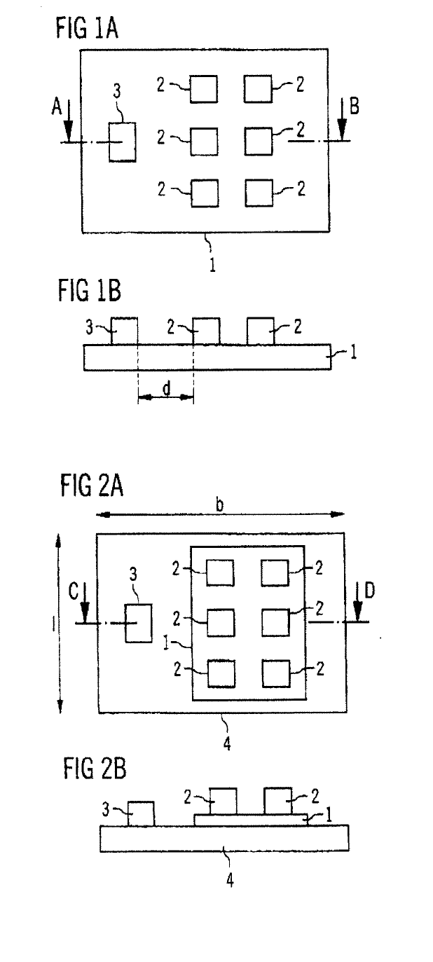

The invention is described in further detail hereinbelow on the basis of three exemplary embodiments in conjunction with FIGS. 1 to 3.

Therein:

FIG. 1a is a schematically illustrated plan view of the chip carrier of a first exemplary embodiment of an LED array according to the invention,

FIG. 1b is a schematic illustration of a cross section along line AB of the first exemplary embodiment of the invention depicted in FIG. 1a,

FIG. 2a is a schematic illustration of a plan view of the carrier body of a second exemplary embodiment of an LED array according to the invention,

FIG. 2b is a schematic illustration of a cross section along line CD of the second exemplary embodiment of the invention depicted in FIG. 2a, and

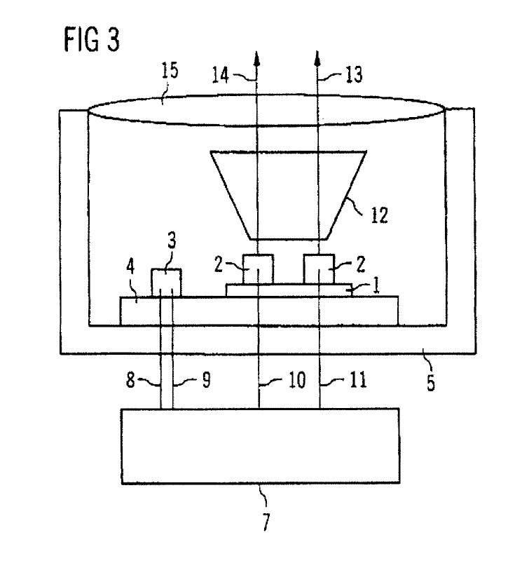

FIG. 3 is a schematic illustration of a cross section through a third exemplary embodiment of an LED array according to the invention.

In the first exemplary embodiment of an LED array according to the invention, illustrated in plan in FIG. 1a and in cross section in FIG. 1b, six LED chips 2 are mounted on the chip carrier 1, none of the individual chips being provided with a housing. The LED chips 2 are, for example, white-light-emitting LED chips 2. The chip carrier 1 is preferably made of a ceramic. The base area of the chip carrier 1 on which the LED chips 2 are mounted is advantageously 300 mm² or less. Attached to the chip carrier 1 is a temperature sensor 3, which can be for example a thermocouple, a temperature-dependent resistor or a semiconductor component. The distance d between the temperature sensor 3 and the nearest LED chip 2 is preferably 5 mm or less. Owing to the small distance between the thermocouple and at least one of the LED chips 2 and the fact that none of the individual LED chips 2 has an LED housing, the temperature at the measuring point of the temperature sensor 3 and the actual temperature of the LED chips 2 are relatively well correlated with each other.

An advantageously small distance between at least one of the LED chips 2 and the temperature sensor 3 can be achieved by using a printing method to apply the temperature sensor 3 to the chip carrier. This is particularly advantageous in the case of a chip carrier made of a ceramic, for example AlN.

In the second exemplary embodiment of an LED array according to the invention, illustrated in plan in FIG. 2a and in cross section in FIG. 2b, a plurality of LED chips 2 is mounted on a common chip carrier 1. The chip carrier 1 is mounted on a carrier body 4, to which the temperature sensor is also attached. The temperature sensor 3 is for example soldered or glued to the carrier body 4.

In this exemplary embodiment as well, the distance between the temperature sensor 3 and the nearest LED chip 2 is advantageously no more than 5 mm. The carrier body 4 is preferably made of a material having good thermal conductivity, for example a metal. In this way, on the one hand, the heat generated by the LED chip 2 can be dissipated through the carrier body 4, and on the other hand, the temperature measured by the temperature sensor 3 is certain to be in good agreement with the actual temperature of the LED chip 2. The carrier body 4 preferably has a base area of 300 mm² or less. For example, the carrier body 4 has a rectangular base area with a length 1 of between 10 mm inclusive and 15 mm inclusive and a width b of between 15 mm inclusive and 20 mm inclusive.

In the exemplary embodiment of an LED array according to the invention illustrated in cross section in FIG. 3, a carrier body 4, to which a chip carrier 1 provided with a plurality of LED chips 2 and a temperature sensor 3 is attached, is built into a housing 5. The temperature sensor 3 is connected by two leads 8, 9 to a control unit 7 disposed outside the housing 5.

The control unit 7 contains an evaluation circuit for evaluating the measurement signal produced by the temperature sensor 3. The control unit 7 also contains a drive circuit that is connected to the evaluation circuit and supplies the LEDs 2, via leads 10, 11, with an operating current that is regulated in accordance with the temperature measured by the temperature sensor 3.

At least one beam-shaping optical element 12 is advantageously disposed after the LED chips 2 in their emission direction 13, 14. Said beam-shaping optical element 12 can for example be a CPC (compound parabolic concentrator), by means of which an advantageous effect is exerted on the emission characteristic of the LED chips 2. For example, the beam divergence of the radiation 13, 14 emitted by the LED chips 2 is reduced by a CPC. A respective beam-shaping element 12 can be disposed after each individual LED 2 in this case. Alternatively, a beam-shaping element 12 can be disposed after all the LEDs together or after one or more sets of LEDs 2.

The beam-shaping optical element 12 can be disposed very closely adjacent the LED chips 2 or even placed thereon.

Still further beam-shaping optical elements can additionally be provided, depending on the desired emission characteristic of the LED array. For example, a lens 15 can be disposed on the housing 5 of the LED array.

The invention is not limited by the description with reference the exemplary embodiment. Rather, the invention encompasses any novel feature and any combination of features, including in particular any combination of features recited in the claims, even if that feature or combination itself is not explicitly mentioned in the claims or exemplary embodiments.

1. An LED array comprising at least two LED chips, wherein-said LED array contains a temperature sensor, and means are provided for regulating an operating current of said LED chips as a function of the temperature detected by said temperature sensor.

2. The LED array as in claim 1, wherein-said LED array includes a chip carrier on which said LED chips are disposed, and said temperature sensor is attached to said chip carrier.

3. The LED array as in claim 2, wherein-said temperature sensor is printed onto said chip carrier.

4. The LED array as in claim 1, wherein said LED array includes a chip carrier on which said LED chips are disposed, said chip carrier being mounted on a carrier body and said temperature sensor being attached to said carrier body.

5. The LED array as in claim 4, wherein said carrier body has a base area of 300 mm² or less.

6. The LED array as in claim 2, wherein said chip carrier has a base area of 300 mm² or less.

7. The LED array as in claim 2, wherein said chip carrier contains a ceramic.

8. The LED array as in claim 1, wherein the distance between at least one of said LED chips and said temperature sensor is 5 mm or less.

9. The LED array as in claim 1, wherein said LED chips of said LED array have no LED housing.

10. The LED arrays as in claim 1, wherein said temperature sensor is a thermocouple.

11. The LED array as in claim 1, wherein said temperature sensor is a temperature-dependent resistor.

12. The LED array as in claim 1, wherein said temperature sensor is a semiconductor component.

13. The LED array as in claim 1, wherein said LED array contains at least four LED chips.

14. The LED array as in claim 1, wherein said LED array comprises an optical element for beam-shaping the radiation emitted by said LED chips.

15. The LED array as in claim 14, wherein said optical element is a CPC-, CEC- or CHC-type optical concentrator.

16. The LED array as in claim 1, wherein said LED array is part of a motor vehicle headlight.

17. The LED array as in claim 3 wherein said chip carrier has a base area of 300 mm² or less.

18. The LED array as in claim 4 wherein said chip carrier has a base area of 300 mm² or less.

19. The LED array as in claim 5 wherein said chip carrier has a base area of 300 mm² or less.

20. The LED array as in claim 4, wherein said chip carrier contains a ceramic.
